(19) United States
(12) Patent Application Publication
(10) Pub. No.: US 2019/0047630 A1
(43) Pub. Date: Feb. 14, 2019

(54) DOUBLE RAFTER FOR VEHICLE ROOF SYSTEM

(71) Applicant: Steven Goff, Syracuse, IN (US)

(72) Inventor: Steven Goff, Syracuse, IN (US)

(21) Appl. No.: 16/102,646

(22) Filed: Aug. 13, 2018

Related U.S. Application Data
(60) Provisional application No. 62/544,687, filed on Aug. 11, 2017.

(51) Int. Cl. B62D 25/06

(52) U.S. Cl. CPC B62D 25/06; B62D 31/02

(57) ABSTRACT

A double rafter for vehicle roof system including a rafter having a top arcuate-member, a base-member, and a plurality of support members. The top arcuate-member is positioned on top of the base-member in a stacked series extending along a length of the base-member when installed. The plurality of support members are disposed between and create a gap between the top arcuate-member and the base-member. The top arcuate-member is supported via the plurality of support members in a partially elevated and contoured position above the base-member. The top arcuate-member comprises a contoured profile to contour to and support an underside of a vehicle roof. The device may be used for installation of a recreational vehicle roof. Further, the device may be used to prevent offset seams in ceiling panels.

### CROSS REFERENCE TO RELATED APPLICATION

The present application is related to and claims priority to U.S. Provisional Patent Application No. 62/544,687 filed Aug. 11, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of roof support and more specifically relates to roof supports for recreational vehicles.

### 2. Description of Related Art

Offset seams, when nailing two 1½″ rafters together can take an extensive amount of time for the builder to replicate. Deck installers have to grind the plywood even when two rafters are uneven. Trimmers are forced to adjust their trim and repair people may spend more time on the job due to offset seams. It can take an excessive amount of time to install rafters on an RV using traditional methods. A suitable solution is desired.

U.S. Pat. No. 9,021,703 to Bernard F. Garceau relates to a method of manufacturing a roof bow. The described method of manufacturing a roof bow includes a method to fabricate a roof bow. A first body element and a second body element each have one or more tabs are both formed from a substrate. The tabs of the first body element are clinched to the second body element. The tabs of the second body element are clinched to the first body element. An upper cord is clinched to a top edge of the coupled body elements and a lower cord is clinched to a bottom edge of the coupled body elements to form the roof bow.

### BRIEF SUMMARY OF THE INVENTION

In view of the foregoing disadvantages inherent in the known roof support art, the present disclosure provides a novel double rafter for vehicle roof system. The general purpose of the present disclosure, which will be described subsequently in greater detail, is to provide a device which saves an extensive amount of time and effort when installing double rafters on an RV roof.

A double rafter for vehicle roof system is disclosed herein. The double rafter for vehicle roof system includes a rafter having a top arcuate-member, a base-member, and a plurality of support members. The top arcuate-member is positioned on top of the base-member in a stacked series extending along a length of the base-member when installed. The plurality of support members are disposed between and create a gap between the top arcuate-member and the base-member. The plurality of support members are in tension and compression relationships with the top arcuate-member and the base-member. The top arcuate-member is supported via the plurality of support members in a partially elevated and contoured position above the base-member. The top arcuate-member comprises a contoured profile configured to contour to and support an underside of a vehicle roof. The device may be used for installation of a recreational vehicle roof. Further, the device may be used to prevent offset seams in ceiling panels.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a double rafter for vehicle roof system, constructed and operative according to the teachings of the present disclosure.

FIG. 1 is a perspective view of the double rafter for vehicle roof system, according to an embodiment of the disclosure.

FIG. 2 is a perspective view of the double rafter for vehicle roof system of FIG. 1, according to an embodiment of the present disclosure.

FIG. 3 is a perspective view of the double rafter for vehicle roof system of FIG. 1, according to an embodiment of the present disclosure.

FIG. 4 is a perspective view of the double rafter for vehicle roof system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a roof support and more particularly to a double rafter for vehicle roof system as used to improve the installation and structural integrity of roofs.

Generally, the present invention provides users with a double rafter for RV roofs designed to strengthen the integrity of the roof. It prevents offset seams in ceiling panels and makes it easier for roof deck installers to apply plywood on the roof and make the job easier. The device saves an extensive amount of time and effort when installing double rafters on an RV roof. It ensures users have a nailer at four-foot intervals.

The present invention eliminates the need to fix offset seams. Double rafter for vehicle roof system is used to prevent offset seams in ceiling panels and make it easier for the roof installer to apply plywood on the roof. The system is 97″ in length, 3″ in width, and 4⅜″ in height. The system can be made from a 2×4 and the top cord can be made with ¾″ plywood or a 1×3 pine. The middle blocks are held in with gang nails. The system is intended to make the installation process for RV roofs easy and more convenient.

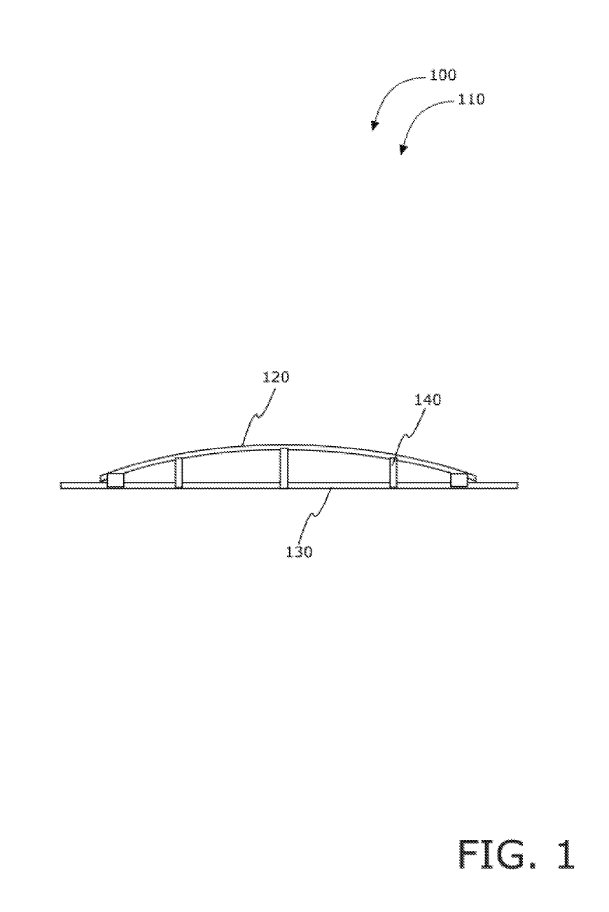

Referring now more specifically to the drawings by numerals of reference, there is shown in FIGS. 1-4, various views of a double rafter for vehicle roof system 100. FIG. 1 shows a double rafter for vehicle roof system 100, according to an embodiment of the present disclosure. As illustrated, the double rafter for vehicle roof system 100 may comprise a rafter 110 including a top arcuate-member 120, a base-member 130, and a plurality of support members 140. The top arcuate-member 120 is positioned on top of the base-member 130 in a stacked series extending along a length of the base-member 130 when installed. The plurality of support members 140 are disposed between the top arcuate-member 120 and the base-member 130. The top arcuate-member 120 is supported via the plurality of support members 140 in a partially elevated and contoured position above the base-member 130. The plurality of support members 140 are in tension and compression relationships with the top arcuate-member 120 and the base-member 130. The plurality of support members 140 comprise a solid member that is vertically placed between the top arcuate-member 120 and the base-member 130. The top arcuate-member 120 comprises a contoured profile configured to contour to and support an underside of a vehicle roof.

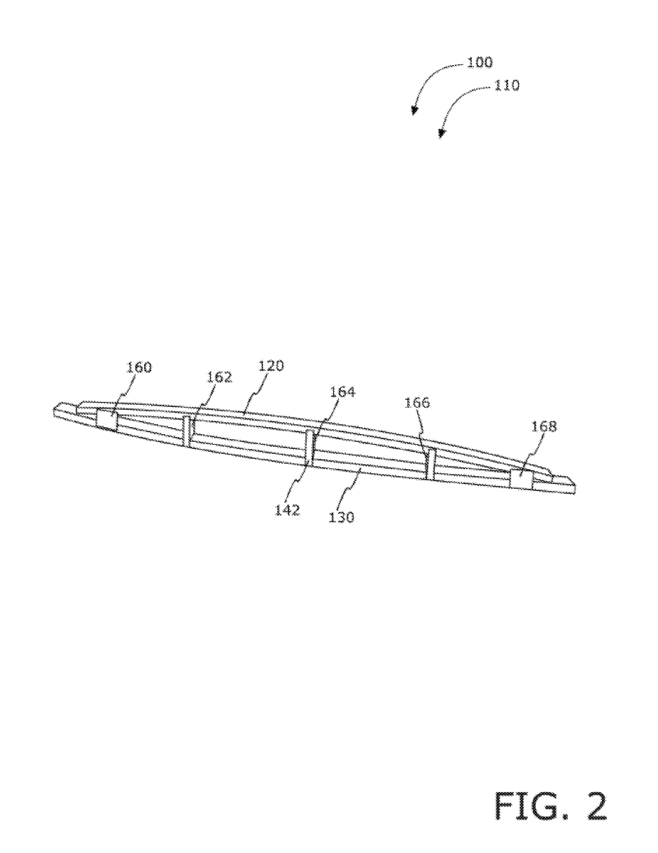

FIGS. 2-4 show various views of the double rafter for vehicle roof system 100 of FIG. 1, according to an embodiment of the present disclosure. As above, the double rafter for vehicle roof system 100 may include the rafter 110 comprising the top arcuate-member 120, the base-member 130, and the plurality of support members 140. In a preferred embodiment, the rafter 110 comprises five of the plurality of support members 140, including a first-support-member 160, a second-support-member 162, a third-support-member 164, a fourth-support-member 166, and a fifth-support-member 168. The first-support-member 160 and the fifth-support-member 168 are substantially similar and securing the top arcuate-member 120 to the base-member 130 at an outer most portion. The second-support-member 162 and the fourth-support-member 166 comprise equal heights. The third-support-member 164 comprises a greater height than the second-support-member 162 and the fourth-support-member 166 creating a rise in a center portion of the top arcuate-member 120.

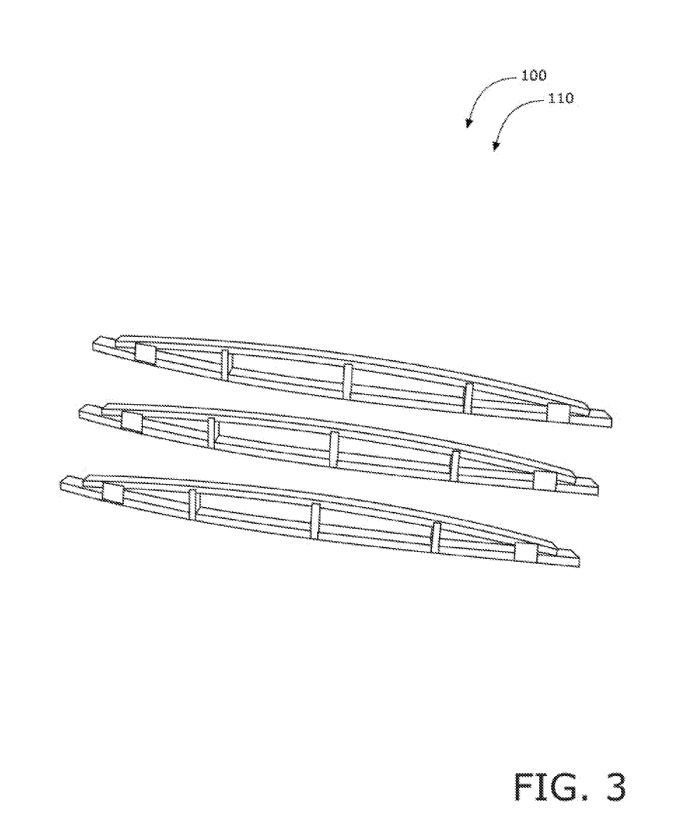

FIG. 3 shows a perspective view of the double rafter for vehicle roof system 100 of FIG. 1, according to an embodiment of the present disclosure. As above, the double rafter for vehicle roof system 100 may include the rafter 110 having a bowstring-like truss structure. The base-member 130 is substantially planar. The base-member 130 comprises a greater-length than a length of the top arcuate-member 120. The rafter 110 comprises a length of approximately 97 inches. The rafter 110 comprises a width of approximately 3 inches. The rafter 110 comprises a height of approximately 4 and ⅜ inches. The plurality of support members 140 are reinforced using fasteners 142. In a preferred embodiment, the fasteners 142 are gang nails. The fasteners 142 further secure the top arcuate-member 120 to the base-member 130. The rafter 110 is normally in tension resisting downward compression forces delivered by a roof-load.

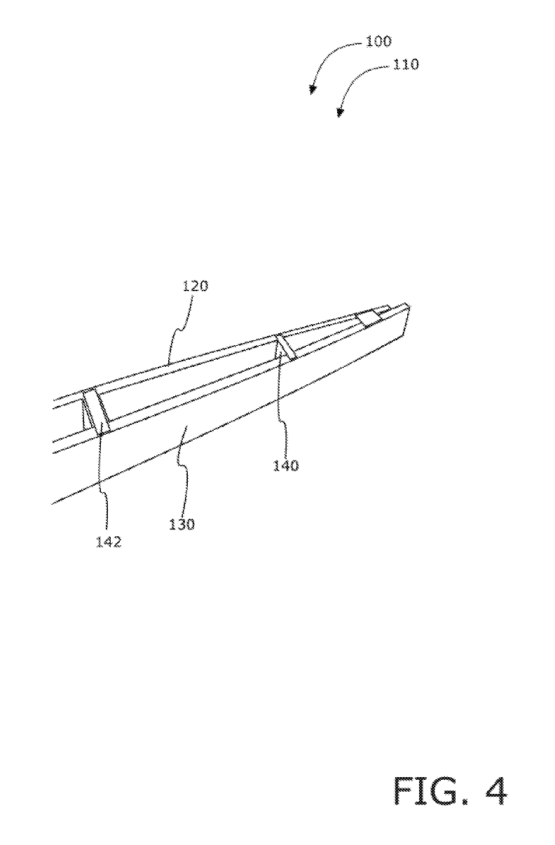

As shown in FIG. 4, the double rafter for vehicle roof system 100 may include the rafter 110 comprising the top arcuate-member 120, the base-member 130, and the plurality of support members 140 used to prevent offset seams in ceiling panels and make roof installation easier. The device further provides structural integrity to a roof of a vehicle such as a recreational vehicle. The top arcuate-member 120 and the base-member 130 comprise wood or other suitable materials. The top arcuate-member 120 is semi-flexible such that an arch is created.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A double rafter for vehicle roof system comprising:
a rafter including;
a top arcuate-member;
a base-member; and
a plurality of support members;
wherein said top arcuate-member is positioned on top of said base-member in a stacked series extending along a length of said base-member when installed;
wherein said plurality of support members are disposed between said top arcuate-member and said base-member;
wherein said top arcuate-member is supported via said plurality of support members in a partially elevated and contoured position above said base-member;
wherein said plurality of support members are in tension and compression relationships with said top arcuate-member and said base-member; and
wherein said top arcuate-member comprises a contoured profile configured to contour to and support an underside of a vehicle roof.

2. The double rafter for vehicle roof system of claim 1, wherein said plurality of support members are equidistantly spaced from one another in a parallel spacial relationship.

3. The double rafter for vehicle roof system of claim 1, wherein said rafter comprises five of said plurality of support members, including a first-support-member, a second-support-member, a third-support-member, a fourth-support-member, and a fifth-support-member.

4. The double rafter for vehicle roof system of claim 3, wherein said first-support-member and said fifth-support-member are substantially similar and securing said top arcuate-member to said base-member at an outer most portion.

5. The double rafter for vehicle roof system of claim 4, wherein said second-support-member and said fourth-support-member comprise equal heights.

6. The double rafter for vehicle roof system of claim 5, wherein said third-support-member comprises a greater height than said second-support-member and said fourth-support-member creating a rise in a center portion of said top arcuate-member.

7. The double rafter for vehicle roof system of claim 1, wherein said rafter comprises a bowstring-like truss structure.

8. The double rafter for vehicle roof system of claim 1, wherein said base-member is substantially planar.

9. The double rafter for vehicle roof system of claim 1, wherein said base-member comprises a greater-length than a length of said top arcuate-member.

10. The double rafter for vehicle roof system of claim 1, wherein said rafter comprises a length of approximately 97 inches.

11. The double rafter for vehicle roof system of claim 11, wherein said rafter comprises a width of approximately 3 inches.

12. The double rafter for vehicle roof system of claim 1, wherein said rafter comprises a height of approximately 4 and ⅜ inches.

13. The double rafter for vehicle roof system of claim 1, wherein said top arcuate-member and said base-member comprise wood.

14. The double rafter for vehicle roof system of claim 1, wherein said vehicle is a recreational vehicle.

15. The double rafter for vehicle roof system of claim 14, wherein said rafter is configured for installation of a roof of said recreational vehicle.

16. The double rafter for vehicle roof system of claim 1, wherein said plurality of support members are reinforced using fasteners.

17. The double rafter for vehicle roof system of claim 16, wherein said fasteners include gang nails.

18. The double rafter for vehicle roof system of claim 17, wherein said fasteners further secure said top arcuate-member to said base-member.

19. The double rafter for vehicle roof system of claim 1, wherein said rafter is normally in tension resisting downward compression forces delivered by a roof-load.

20. A double rafter for vehicle roof system, the double rafter for vehicle roof system comprising:
a rafter including;
a top arcuate-member;
a base-member; and
a plurality of support members;
wherein said top arcuate-member is positioned on top of said base-member in a stacked series extending along a length of said base-member when installed;
wherein said plurality of support members are disposed between said top arcuate-member and said base-member;
wherein said top arcuate-member is supported via said plurality of support members in a partially elevated and contoured position above said base-member;
wherein said plurality of support members are in tension and compression relationships with said top arcuate-member and said base-member;
wherein said top arcuate-member comprises a contoured profile configured to contour to and support an underside of a vehicle roof;
wherein said plurality of support members are equidistantly spaced from one another in a parallel spacial relationship;
wherein said rafter comprises five of said plurality of support members, including a first-support-member, a second-support-member, a third-support-member, a fourth-support-member, and a fifth-support-member;
wherein said first-support-member and said fifth-support-member are substantially similar and securing said top arcuate-member to said base-member at an outer most portion;
wherein said second-support-member and said fourth-support-member comprise equal heights;
wherein said third-support-member comprises a greater height than said second-support-member and said fourth-support-member creating a rise in a center portion of said top arcuate-member;
wherein said rafter comprises a bowstring-like truss structure;
wherein said base-member is substantially planar;
wherein said base-member comprises a greater-length than a length of said top arcuate-member;
wherein said rafter comprises a length of approximately 97 inches;
wherein said rafter comprises a width of approximately 3 inches;
wherein said rafter comprises a height of approximately 4 and ⅜ inches;
wherein said top arcuate-member and said base-member comprise wood;
wherein said vehicle is a recreational vehicle;
wherein said rafter is configured for installation of a roof of said recreational vehicle;
wherein said plurality of support members are reinforced using fasteners;
wherein said fasteners include gang nails;
wherein said fasteners further secure said top arcuate-member to said base-member; and
wherein said rafter is normally in tension resisting downward compression forces delivered by a roof-load.
